(19) United States
(12) Patent Application Publication
(10) Pub. No.: US 2025/0317904 A1
(43) Pub. Date: Oct. 9, 2025

(54) TRANSMISSION AND RECEPTION IN A SHARED RESOURCE

(71) Applicant: Samsung Electronics Co., Ltd., Suwon-si (KR)

(72) Inventors: Emad Nader Farag, Flanders, NJ (US); Aristides Papasakellariou, Houston, TX (US); Ebrahim MolavianJazi, San Jose, CA (US); Carmela Cozzo, San Diego, CA (US)

(21) Appl. No.: 19/084,722

(22) Filed: Mar. 19, 2025

Related U.S. Application Data
(60) Provisional application No. 63/573,955, filed on Apr. 3, 2024.

(51) Int. Cl. H04W 72/02; H04W 72/21; H04W 72/232

(52) U.S. Cl. CPC H04W 72/02; H04W 72/21; H04W 72/232

(57) ABSTRACT

Apparatuses and methods for transmission or reception in a shared resource. A method of operating a user equipment (UE) includes receiving configuration information of a resource for an uplink (UL) transmission and receiving an indicator associated with the resource. The indicator indicates a level of sensing for the resource. The method further includes determining a presence of data for transmission on the resource, performing sensing based on the level of sensing to determine availability of the resource, and when the resource is determined to be available, transmitting the data in the resource starting after a gap of M symbols from an end time of sensing, where M is a non-negative integer.

### CROSS-REFERENCE TO RELATED AND CLAIM OF PRIORITY

The present application claims priority under 35 U.S.C. § 119 (e) to: U.S. Provisional Patent Application No. 63/573,955 filed on Apr. 3, 2024, which is hereby incorporated by reference in its entirety.

### TECHNICAL FIELD

The present disclosure relates generally to wireless communication systems and, more specifically, the present disclosure is related to apparatuses and methods for transmission or reception in a shared resource.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to transmission in a shared resource.

In one embodiment, a user equipment (UE) is provided. The UE includes a transceiver configured to receive configuration information of a resource for uplink (UL) transmission and receive an indicator associated with the resource, wherein the indicator indicates a level of sensing for the resource. A processor operably coupled to the transceiver. The processor is configured to determine a presence of data for transmission on the resource. The transceiver is further configured to perform sensing based on the level of sensing to determine availability of the resource, and when the resource is determined to be available, transmit the data in the resource starting after a gap of M symbols from an end time of sensing, where M is a non-negative integer.

In another embodiment, a base station (BS) is provided. The BS includes a transceiver configured to transmit configuration information of a resource for an UL transmission and transmit an indicator associated with the resource, wherein the indicator indicates a level of sensing for the resource. The BS further includes a processor operably coupled to the transceiver. The processor is configured to determine whether a first transmission is present in the resource associated with a first level of sensing. The transceiver is further configured to, when the first transmission is present, receive the first transmission. The processor is further configured to, when the first transmission is not present, determine whether a second transmission is present in the resource associated with a second level of sensing. The transceiver is further configured to, when the second transmission is present, receive the second transmission.

In yet another embodiment, a method of operating a UE is provided. The method includes receiving configuration information of a resource for an UL transmission and receiving an indicator associated with the resource. The indicator indicates a level of sensing for the resource. The method further includes determining a presence of data for transmission on the resource, performing sensing based on the level of sensing to determine availability of the resource, and when the resource is determined to be available, transmitting the data in the resource starting after a gap of M symbols from an end time of sensing, where M is a non-negative integer.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIG. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates a flowchart of an example procedure for transmitting on allocated resource(s) according to embodiments of the present disclosure;

FIG. 7 illustrates a flowchart of an example procedure for transmitting on allocated resource(s) according to embodiments of the present disclosure;

FIG. 8 illustrates a flowchart of an example procedure for transmitting on allocated resource(s) according to embodiments of the present disclosure;

FIG. 9 illustrates a flowchart of an example procedure for transmitting on allocated resource(s) according to embodiments of the present disclosure;

FIG. 10 illustrates a flowchart of an example procedure for transmitting on allocated resource(s) according to embodiments of the present disclosure;

FIGS. 11A and 11B illustrate diagrams of example resource configurations according to embodiments of the present disclosure;

FIGS. 12A and 12B illustrate diagrams of example resource configurations according to embodiments of the present disclosure;

FIGS. 13A, 13B, 13C, 13D, and 13E illustrate diagrams of example resource configurations according to embodiments of the present disclosure;

FIG. 14 illustrates a flowchart of an example UE procedure for transmitting on a shared resource according to embodiments of the present disclosure;

FIG. 15 illustrates a flowchart of an example UE procedure for transmitting data on a shared resource according to embodiments of the present disclosure;

FIG. 16 illustrates a flowchart of an example UE procedure for transmitting on a shared resource according to embodiments of the present disclosure;

FIGS. 17A and 17B illustrate diagrams of example resource configurations according to embodiments of the present disclosure; and

FIG. 18 illustrates an example method performed by a UE in a wireless communication system according to embodiments of the present disclosure.

### DETAILED DESCRIPTION

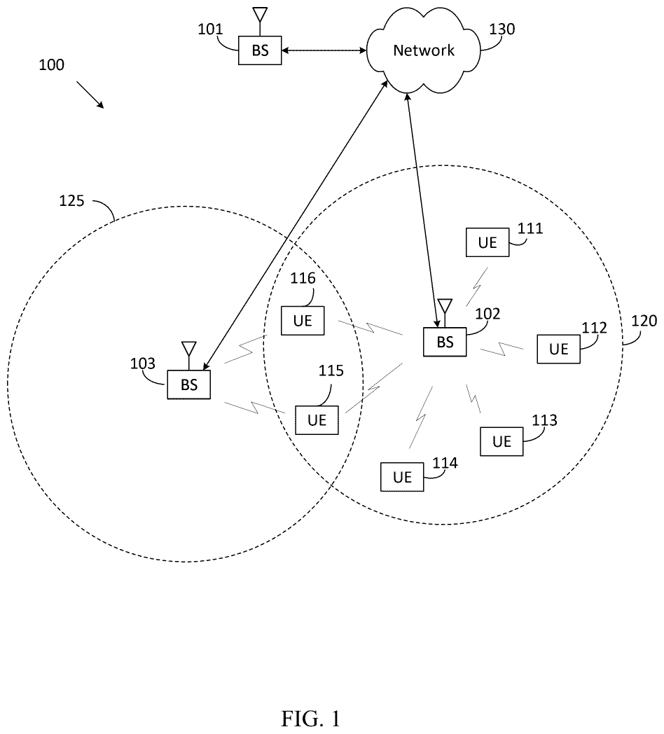

FIGS. 1-18, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v18.1.0, “NR; Physical channels and modulation;” [REF 2] 3GPP TS 38.212 v18.1.0, “NR; Multiplexing and Channel coding;” [REF 3] 3GPP TS 38.213 v18.1.0, “NR; Physical Layer Procedures for Control;” [REF 4] 3GPP TS 38.214 v18.1.0, “NR; Physical Layer Procedures for Data;” [REF 5] 3GPP TS 38.321 v18.0.0, “NR; Medium Access Control (MAC) protocol specification;” and [REF 6] 3GPP TS 38.331 v18.0.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, (BS)), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for transmission or reception in a shared resource. In certain embodiments, one or more of the BSs 101-103 include circuitry, programing, or a combination thereof to for transmission or reception in a shared resource.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

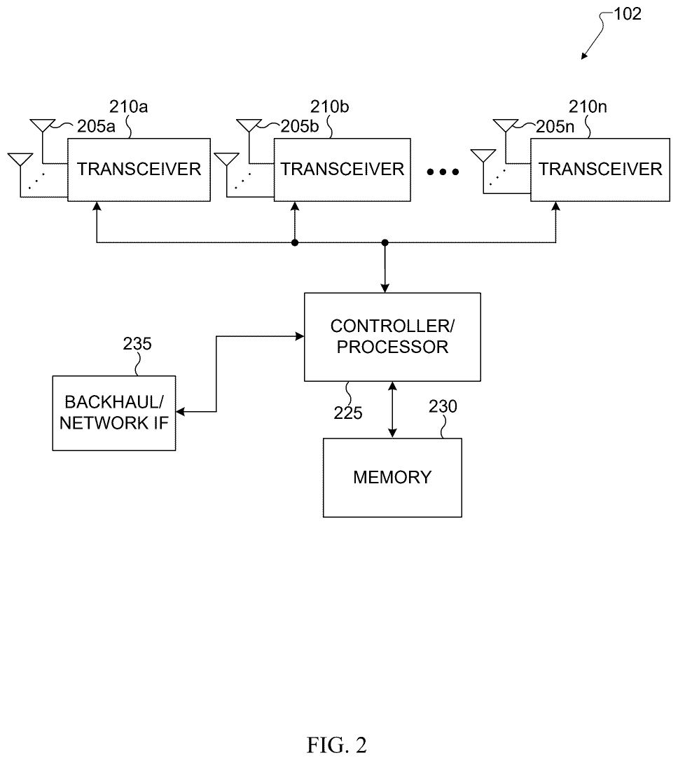

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for transmission in a shared resource. Any of a wide variety of other functions could be supported in the gNB 102 by the controller/processor 225.

The controller/processor 225 is also capable of executing programs and other processes resident in the memory 230, such as processes to support transmission or reception in a shared resource as described in embodiments of the present disclosure. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

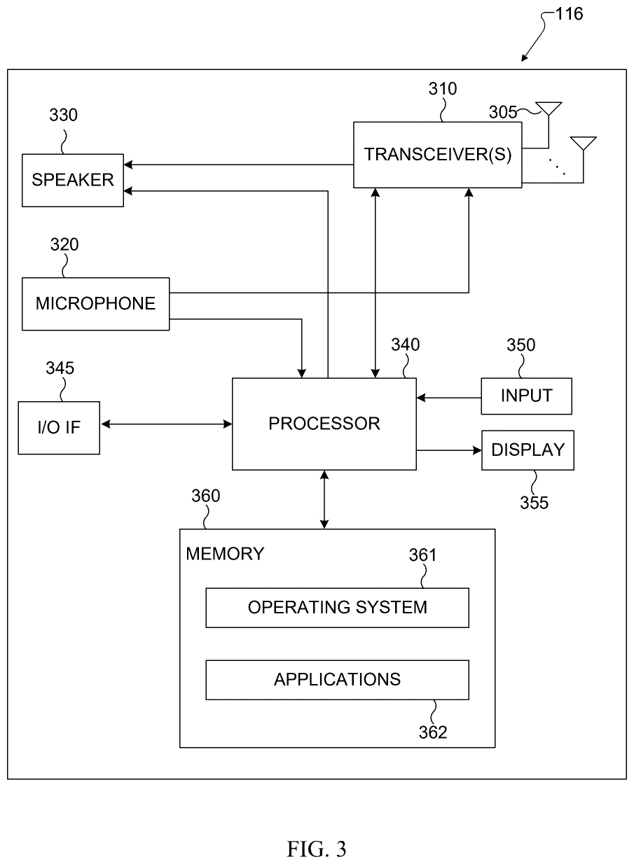

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for utilizing transmission in a shared resource as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

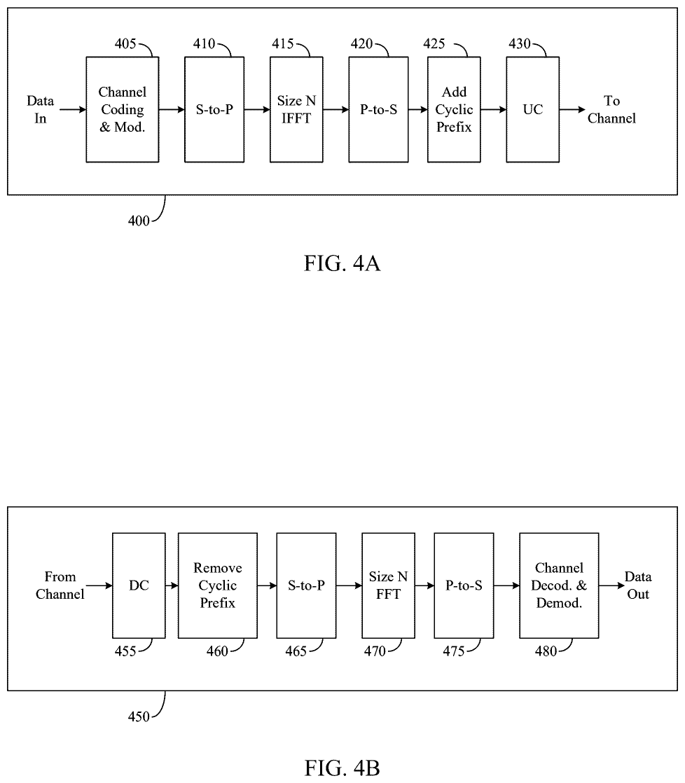

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured to perform transmission in a shared resource as described in embodiments of the present disclosure. In some embodiments, the reception path 450 is configured to perform reception in a shared resource as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In embodiments of the present disclosure, a beam is determined by either a transmission configuration indicator (TCI) state that establishes a quasi-colocation (QCL) relationship between a source reference signal (RS) (e.g., SS/PBCH Block (SSB) and/or Channel State Information Reference Signal (CSI-RS)) and a target RS or a spatial relation information that establishes an association to a source RS, such as SSB or CSI-RS or sounding RS (SRS). In either case, the ID of the source reference signal or the ID of the TCI state or the ID of the spatial relation identifies the beam. The TCI state and/or the spatial relation reference RS can determine a spatial RX filter for reception of downlink channels at the UE 116, or a spatial TX filter for transmission of uplink channels from the UE 116.

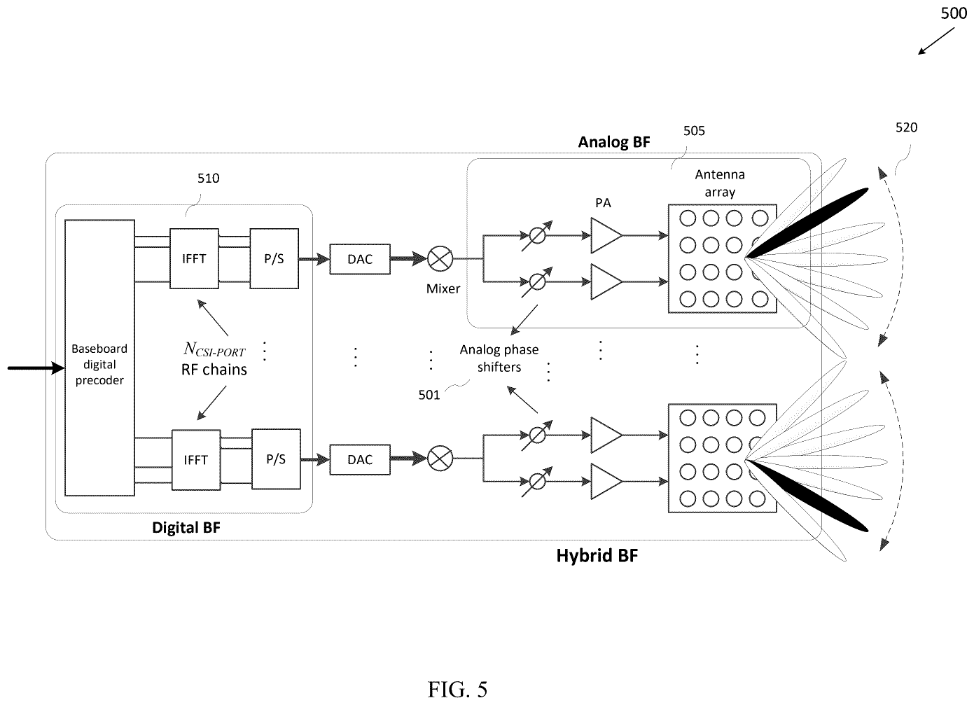

FIG. 5 illustrates an example of a transmitter structure 500 for beamforming according to embodiments of the present disclosure. In certain embodiments, one or more of gNB 102 or UE 116 includes the transmitter structure 500. For example, one or more of antennas 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz. In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

A unit for DL signaling, for UL signaling or for SL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems (see also REF 1). In addition, a slot can have symbols for SL communications.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE (e.g., the UE 116) can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS)-see also REF 1. A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used (see also REF 4). A CSI process includes NZP CSI-RS and CSI-IM resources. A UE can determine CSI-RS transmission parameters through DL control signaling or higher layer signaling, such as radio resource control (RRC) signaling from a gNB (see also REF 6). Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access (see also REF 1). A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in its buffer, and CSI reports enabling a gNB to select appropriate parameters for PDSCH or PDCCH transmissions to a UE, UCI can also include link recovery request (LLR) to indicate beam failure. HARQ-ACK information can be configured to be with a smaller granularity than per TB and can be per data code block (CB) or per group of data CBs where a data TB includes a number of data CBs. A CSI report from a UE can include a channel quality indicator (CQI) informing a gNB of a largest modulation and coding scheme (MCS) for the UE to detect a data TB with a predetermined block error rate (BLER), such as a 10% BLER (see also REF 3), of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random access channel (physical random access channel (PRACH), see also REF 3 and REF 4).

SL signals and channels are transmitted and received on sub-channels within a resource pool, where a resource pool is a set of time-frequency resources used for SL transmission and reception within a SL BWP. SL channels include physical SL shared channels (PSSCHs) conveying data information, physical SL control channels (PSCCHs) conveying SL control information (SCI) for scheduling transmissions/receptions of PSSCHs, physical SL feedback channels (PSFCHs) conveying hybrid automatic repeat request acknowledgement (HARQ-ACK) information in response to correct (ACK value) or incorrect (negative acknowledgment (NACK) value) transport block receptions in respective PSSCHs, PSFCH can also carry conflict information, and physical SL Broadcast channel (PSBCH) conveying system information to assist in SL synchronization. SL signals include demodulation reference signals demodulation reference signal (DM-RS) that are multiplexed in PSSCH or PSCCH transmissions to assist with data or SCI demodulation, channel state information reference signals (CSI-RS) for channel measurements, phase tracking reference signals (PT-RS) for tracking a carrier phase, SL primary synchronization signals (S-PSS) and SL secondary synchronization signals (S-SSS) for SL synchronization, and SL positioning reference signal (S-PRS) for SL positioning. The SCI can be split into two parts/stages corresponding to two respective SCI formats; the first SCI format is multiplexed on a PSCCH, while the second SCI format is multiplexed along with SL data on a PSSCH that is transmitted in physical resources indicated by the first SCI format.

In this disclosure, a beam can be determined by any of:
A TCI state, that establishes a quasi-colocation (QCL) relationship or spatial relation between a source reference signal (e.g. SSB and/or CSI-RS) and a target reference signal, and
A spatial relation information that establishes an association to a source reference signal, such as SSB or CSI-RS or SRS.

In either case, the ID of the source reference signal or the ID of the TCI state or the ID of the spatial relation identifies the beam. The TCI state and/or the spatial relation reference RS can determine a spatial Rx filter or quasi-co-location information for reception of downlink channels at the UE, or a spatial Tx filter for transmission of uplink channels from the UE. The TCI state and/or the spatial relation reference RS can determine a spatial Tx filter for transmission of downlink channels from the gNB (e.g., the BS 102), or a spatial Rx or quasi-co-location information filter for reception of uplink channels at the gNB.

Rel-17 introduced the unified TCI framework, where a unified or master or main or indicated TCI state is signaled to the UE. The unified or master or main or indicated TCI state can be one of:
1. In case of joint TCI state indication, wherein a same beam is used for DL and UL channels, a joint TCI state that can be used at least for UE-dedicated DL channels and UE-dedicated UL channels.
2. In case of separate TCI state indication, wherein different beams are used for DL and UL channels, a DL TCI state that can be used at least for UE-dedicated DL channels.
3. In case of separate TCI state indication, wherein different beams are used for DL and UL channels, a UL TCI state that can be used at least for UE-dedicated UL channels.

The unified (master or main or indicated) TCI state is TCI state of UE-dedicated reception on PDSCH/PDCCH or dynamic-grant/configured-grant based PUSCH and dedicated PUCCH resources.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state can be associated with a TRP of a cell having a PCI different from the PCI of the serving cell).

Quasi-co-location (QCL) relation, can be quasi-location with respect to one or more of the following relations [38.214—section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g. non-UE dedicated channel and sounding reference signal (SRS).

A UE is indicated a TCI state by MAC CE when the MAC CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI format can be with a DL assignment for PDSCH reception or without a DL assignment. A TCI state (TCI state code point) indicated in a DL related DCI format is applied after a beam application time from the corresponding HARQ-ACK feedback

In this disclosure, aspects are provided related to sharing a channel between multiple users (UEs) and methods to avoid collisions between users sharing the channel. These methods can also be used when a wireless channel is shared by multiple operators.

A wireless channel is a shared channel that can be used by more than one user. To avoid collisions between users, resource allocation schemes are used. Resource allocation schemes can be dynamic or semi-static. Resource allocation schemes have different requirements and constraints such as dealing with traffic having different transmission characteristics (e.g., periodic vs sporadic, transport block size, etc.) and having different quality-of-service (QoS) profiles (e.g., latency, priority, etc.) for different users. At the same time, resource allocation schemes are excepted to efficiently utilized the bandwidth of the wireless channel. Some of these requirements and constraints can be seemingly contradictory.

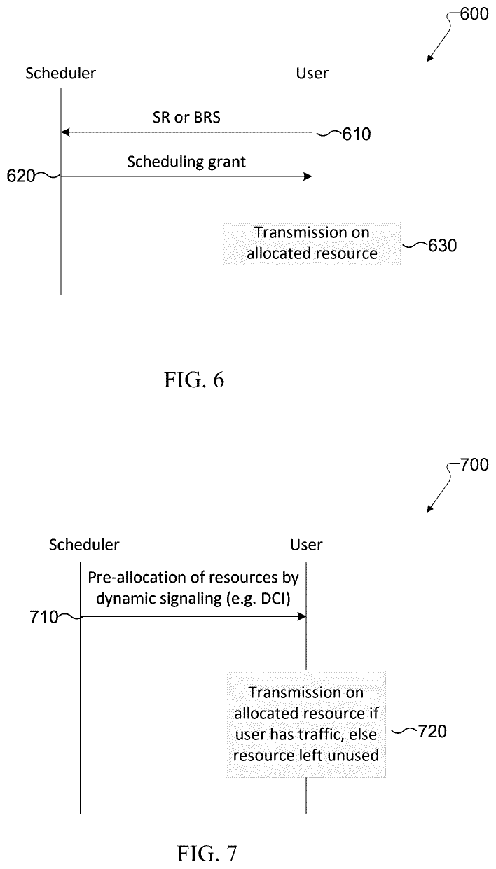

FIG. 6 illustrates a flowchart of an example procedure 600 for transmitting on allocated resource(s) according to embodiments of the present disclosure. For example, procedure 600 can be performed by any of the UEs 111-116 of FIG. 1 and a scheduler. This example is for illustration only and other embodiments can be used without departing from the scope of the present disclosure.

The procedure begins in 610, a user/UE transmits a SR or BSR to a scheduler. For example, as used herein, the scheduler is a network entity that performs resource scheduling for a cell and/or a wireless network. The scheduler may be or be implemented in a BS, such as anyone of gNBs 101-103 or in network 130 in FIG. 1. In 620, the scheduler transmits a scheduling grant to the UE/user. In 630, the user/UE performs a transmission on an allocated resource.

For example, in case of dynamic resource allocation, a user can send a scheduling request (SR) or buffer status report (BSR) to a scheduler, when the user requires resources to transmit over the wireless channel, the scheduler allocates resources to the user and sends a scheduling grant indicating the allocated resources to the user, the user then uses the scheduling grant to transmit over the wireless channel as illustrated in FIG. 6. However, embodiments of the present disclosure recognize that this procedure of sending a SR/BSR and waiting for a scheduling grant before transmitting increases latency and will not meet latency requirements for ultra-reliable low latency communications (URLLC) or hyper-reliable low latency communicates (HRLLC).

FIG. 7 illustrates a flowchart of an example procedure 700 for transmitting on allocated resource(s) 700 according to embodiments of the present disclosure. For example, procedure 700 can be performed by any of the UEs 111-116 of FIG. 1, such as the UE 111, and any scheduler described herein. This example is for illustration only and other embodiments can be used without departing from the scope of the present disclosure.

The procedure begins in 710, a scheduler transmits a pre-allocation of resources by dynamic signaling (e.g., DCI) to a UE/user. In 720, the UE/user performs a transmission on allocated resources if the user has traffic. Otherwise, the resource is left unused.

Alternatively, the scheduler can pre-allocate resources to the user by allocating resources to the user before the scheduler is aware that the user has traffic to transmit. If the user has traffic to transmit, it uses the allocated resource (hence reducing latency). However, embodiments of the present disclosure further recognize that if the user has no traffic to transmit the resource is left unused, hence wasting wireless channel resources and leading to lower wireless channel resource utilization efficiency. This is illustrated in FIG. 7.

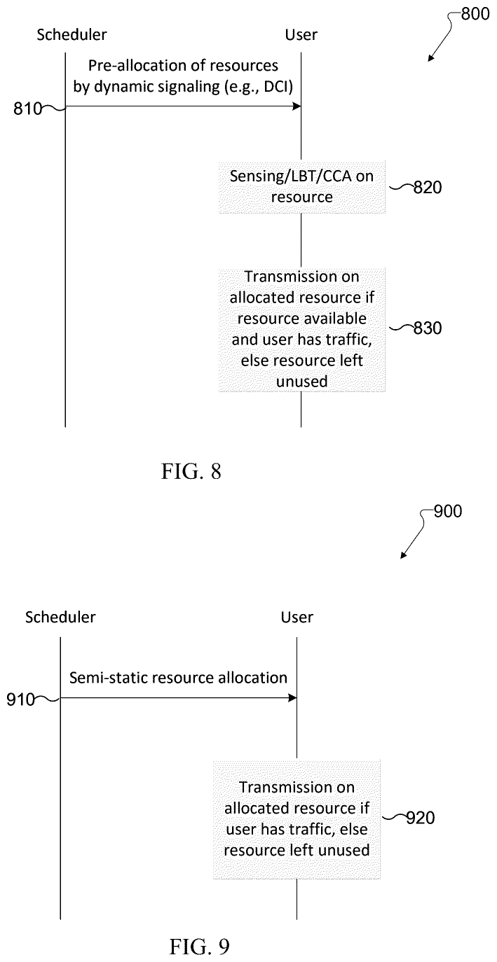

FIG. 8 illustrates a flowchart of an example procedure 800 for transmitting on allocated resource(s) 800 according to embodiments of the present disclosure. For example, procedure 800 can be performed by any of the UEs 111-116 of FIG. 1, such as the UE 112, and any scheduler described herein. This example is for illustration only and other embodiments can be used without departing from the scope of the present disclosure.

The procedure begins in 810, a scheduler transmits a pre-allocation of resources by dynamic signaling (e.g., DCI) to a UE/user. In 820, the UE/user performs sensing/listen-before-talk (LBT)/clear channel assessment (CCA) on the resource, e.g., if the UE/user has traffic to transmit on the resource. In 830, the UE/user performs a transmission on the allocated resource if the resource is available and the user/UE has traffic. Otherwise, the resource is left unused.

To address this issue, the scheduler can pre-allocate resources to multiple users, a user that has traffic to send can use the resource. However, users are unaware, of the traffic status or transmission status of other users allocated the same resource. In fact, users may not be even aware that other users have been allocated the same resource. Embodiments of the present disclosure further recognize that this can lead to collision between users' transmissions. To mitigate this issue, users (e.g., when a user has traffic to transmit in the allocated resource) can assess or check the status of the resource by sensing the channel before transmitting on the resource, (e.g., performing a listen-before-talk (LBT) procedure), this clear channel assessment (CCA) can then be used to determine whether the user transmits in this resource or skips the resource as illustrated in FIG. 8. If the resource is not being used by another user, and the user has data to transmit, the user can transmit in the resource, otherwise the user doesn't transmit in the resource. Embodiments of the present disclosure further recognize that if users allocated to a resource perform sensing/LBT/CCA at the same time and then start transmitting the same time, collisions on the resource may not be detected. Users allocated to the resource can start transmitting at different times (e.g., based on an indicator (e.g., level of sensing indicator) from the scheduler or a priority from the scheduler, the indicator can be included in the DCI Format scheduling the UL resource), a user that starts transmitting later in the resource can determine if the resource is used or not by a user that starts transmitting earlier in the resource as described in this disclosure. In one example, the level of sensing can indicate no sensing, and the user directly transmits in the resource if it has data to transmit. In one example, the indicator/level of sensing/priority is configured/activated semi-statically (e.g., RRC signaling or MAC CE or L1 control) and can apply to multiple transmissions until a new indicator/level of sensing/priority is configured/activated. In one example, the indicator/level of sensing/priority is indicated by L1 control signaling (e.g., DCI Format), and applies to a transmission(s) scheduled by the L1 control signaling (e.g., DCI Format).

FIG. 9 illustrates a flowchart of an example procedure 900 for transmitting on allocated resource(s) according to embodiments of the present disclosure. For example, procedure 900 can be performed by any of the UEs 111-116 of FIG. 1, such as the UE 113, and any scheduler described herein. This example is for illustration only and other embodiments can be used without departing from the scope of the present disclosure.

The procedure begins in 910, a scheduler transmits a semi-static resource allocation to a UE/user, for example this can be a configured grant PUSCH (CG-PUSCH). In 910, the UE/user performs a transmission on the allocated resource if the UE/user has traffic. Otherwise, the resource is left unused. In one example, the CG-PUSCH can be type-1 CG PUSCH. In one example, the CG-PUSCH can be type-2 CG PUSCH, wherein the type-2 CG-PUSCH is further activated by dynamic signaling (e.g., MAC CE or DCI Format).

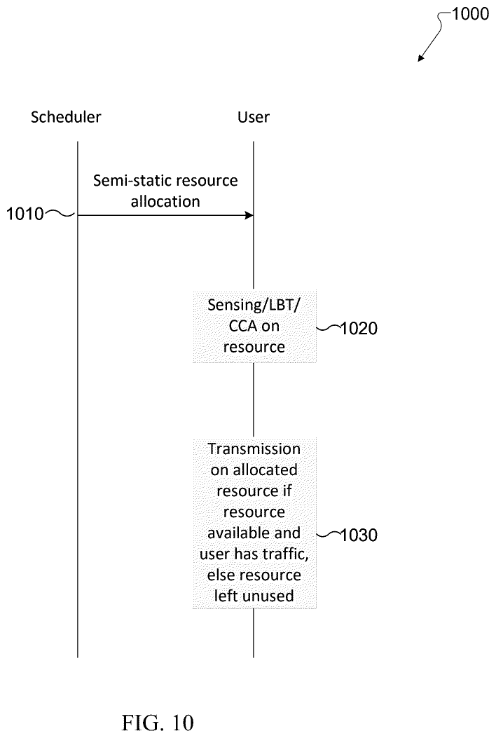

FIG. 10 illustrates a flowchart of an example procedure 1000 for transmitting on allocated resource(s) 900 according to embodiments of the present disclosure. For example, procedure 1000 can be performed by any of the UEs 111-116 of FIG. 1, such as the UE 114, and any scheduler described herein. This example is for illustration only and other embodiments can be used without departing from the scope of the present disclosure.

The procedure begins in 1010, a scheduler transmits a semi-static resource allocation to a UE/user. In 1020, the UE/user performs sensing/LBT/CCA on the resource, e.g., if the UE/user has traffic to transmit on the resource. In 1030, the UE/user performs a transmission on the allocated resource if the resource is available and the user/UE has traffic. Otherwise, the resource is left unused.

In another example, for semi-static resource allocation a set of resources can be allocated to a user, for example, the set of resource can be allocated with a periodicity (e.g., periodic time T, where every period T a resource is allocated to a user) as illustrated in FIG. 9. This can be beneficial when the user has periodic traffic, the user uses the semi-static allocated resource without the need for further signaling. This can lead to lower latency. However, embodiments of the present disclosure further recognize that if a user has no traffic to transmit, the resource is left unused thus wasting wireless channel resources and leading to lower wireless channel resource utilization efficiency. To address this, the scheduler/network can semi-statically configure the resource(s) to multiple users. A user that has traffic to send can use the resource. However, users are unaware, of the traffic status or transmission status of other users allocated the same resource. In fact, users may not be even aware that other users have been allocated the same resource. This can lead to collision between users' transmissions. To mitigate this issue, users (e.g., when a user has traffic to transmit in the allocated resource) can assess or check the status of the resource by sensing the channel before transmitting on the resource, (e.g., performing a listen-before-talk (LBT) procedure), this clear channel assessment (CCA) can then be used to determine whether the user transmits in this resource or skips the resource as illustrated in FIG. 10. If the resource is not being used by another user, and the user has data to transmit, the user can transmit in the resource, otherwise the user doesn't transmit in the resource. Embodiments of the present disclosure further recognize that if users allocated/configured to a resource perform sensing/LBT/CCA at the same time and then start transmitting at the same time, collisions on the resource may not be detected. Users allocated to the resource can start transmitting at different times (e.g., based on a configuration parameter or indication (e.g., level of sensing indicator) from network or the scheduler or a priority from network or the scheduler), a user that starts transmitting later in the resource can determine if the resource is used or not by a user that starts transmitting earlier in the resource as described in this disclosure. In one example, the level of sensing can indicate no sensing, and the user directly transmits in the resource if it has data to transmit. In one example, the indicator/level of sensing/priority is configured/activated semi-statically (e.g., RRC signaling or MAC CE or L1 control) and can apply to multiple transmissions until a new indicator/level of sensing/priority is configured/activated.

In this disclosure a user can be a UE allocated/configured resources by the network (e.g., the network 130) or scheduler semi-statically or dynamically. In this disclosure a user can be operator when multiple operators are sharing the same spectrum/resources. For example, a first operator can be configured with a first level of sensing (e.g., to use the resource from the start of the resource without sensing), and a second operator can be configured with a second level of sensing (e.g., when there is traffic to transmit, to first sense the resource based on a level of sensing, and if the resource is available to transmit in the resource, else if the resource is not available and there is no transmission).

In this disclosure, a user or UE or transmitting device can be configured with a level of sensing of a resource or for some resources or for all resources configured/activated/indicated to the user. In this disclosure, the level of sensing is referred to as priority. For example, the higher the priority of the user or resource the less the sensing (e.g., a lower sensing duration for a user to transmit). In one example, a higher priority user can transmit in the resource if data is available with no sensing. In one example, a lower priority user, performs sensing first to determine if a resource is available before transmitting in the resource when the resource is available. In one example, the sensing level is determined by a number of symbols to sense and/or a threshold to compare the sensing metric against. In one example, higher priority users or resources have a lower sensing duration. In one example, the highest priority user has no sensing, e.g., can transmit in the resource if it has data available for transmission.

In this disclosure, a UE or user or transmitting device configured with a sensing level can be: (1) User equipments transmitting in the uplink in a same network (e.g., with a same operator). (2) User equipments transmitting in the uplink in a different networks (e.g., with different operators), for example, a first operator can be an incumbent operator in the spectrum or a higher priority operator, a user scheduled to transmit in the UL by the first operator can be indicated a higher priority (e.g., no or less sensing to determine resource availability), a second operator can be an operator sharing the spectrum opportunistically with the first operator or a lower priority operator, a user scheduled to transmit in the UL by the second operator can be indicated a lower priority (e.g., more sensing to determine resource availability). (3) Downlink transmissions in a different networks (e.g., with different operators), for example, a first operator can be an incumbent operator in the spectrum or a higher priority operator, a DL transmission by the first operator can have a higher priority (e.g., no or less sensing to determine resource availability), a second operator can be an operator sharing the spectrum opportunistically with the first operator or a lower priority operator, a DL transmission by the second operator can be indicated a lower priority (e.g., more sensing to determine resource availability).

The present disclosure relates to a NR/5G and/or 6G communication system.

This disclosure provides aspects related to user or transmitting device initiated transmissions in a shared resource.
A user or transmitting device can perform sensing/listen-before-talk (LBT)/clear channel assessment (CCA) before transmitting in a resource.
Whether or not a user performs sensing/LBT/CCA and the level of sensing/LBT/CCA is indicated or activated or configured to the user or transmitting device.
Staggered starting transmission time in a resource as configured or activated or indicated to the UE or transmitter.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

In the following, both frequency division duplexing (FDD) and time division duplexing (TDD) are regarded as a duplex method for DL and UL signaling. In addition, full duplex (XDD) operation is possible, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE or can be UE common (e.g., to a group of UEs or each of the UEs of a cell). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., UCI on PUCCH or PUSCH). L1 control signaling be UE-specific e.g., to one UE or can be UE common (e.g., to a group of UEs or to each of the UEs of a cell).

In this disclosure, configuration can refer to configuration by semi-static signaling (e.g., RRC or SIB signaling). In one example, a configuration can be applicable to multiple transmission instances, until a new configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In this disclosure a list with N elements can be denoted as L(i), where i can take N values, and L(i) can correspond to the element or entry associated with index i. In one example, i can take N arbitrary values. In one example, i=0, 1, . . . , N−1. In one example, i=1, 2, . . . , N. In one example, i is an identity of an element or entry in the list.

In the present disclosure, the term “activation” describes an operation wherein a UE receives and decodes first information provided by a first signal from the network (or gNB) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated, or is otherwise define in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group of RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

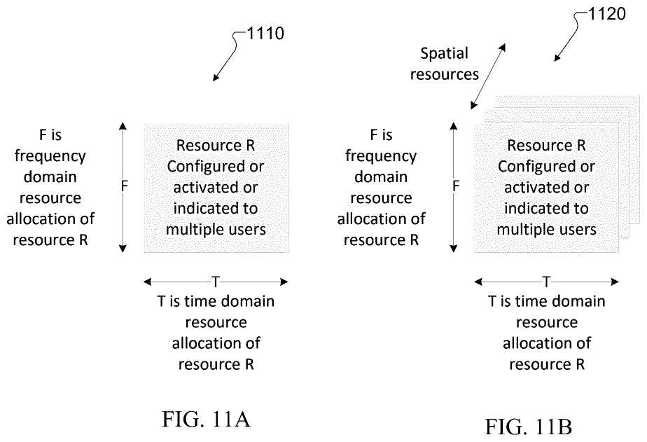

FIGS. 11A and 11B illustrate diagrams of example resource configurations 1110 and 1120 according to embodiments of the present disclosure. For example, resource configurations 1110 and 1120 can be received by any of the UEs 111-116 of FIG. 1 and/or any of the users described herein. This example is for illustration only and other embodiments can be used without departing from the scope of the present disclosure.

A resource R is configured or activated or indicated for multiple users. In one example, the resource R is allocated to resources in time and frequency domains as illustrated in FIG. 11A. In another example, the resource R is allocated to resources in time and frequency and spatial domains as illustrated in FIG. 11B. In one example, the time domain resource allocation of resource R is T, wherein T can be in symbols and/or slots and/or subframes and/or frames. In one example, T determines the start and/or length and/or end of resource R in time domain. In one example, the frequency domain resource allocation of resource R is F, wherein F can be a number of sub-carriers and/or RBs and/or sub-channels (wherein a sub-channel is a group of RBs). In one example, F determines the start and/or length and/or end of resource R in frequency domain. In one example, spatial domain resource can include beam(s) or spatial domain filter(s). In one example, spatial domain resource can include antenna port(s) of reference signals (e.g., synchronization signal/physical broadcast channel (SS/PBCH) blocks or CSI-RS or SRS or DMRS). In one example, spatial domain resource can include reference signals (e.g., source reference signal for quasi-co-location), (e.g., SS/PBCH blocks or CSI-RS or SRS or DMRS). In one example, spatial domain resource can include layer(s). In one example, spatial domain can include TCI state(s) or spatial relation(s).

In one example, resource R is configured by higher layer signaling (e.g., RRC dedicated signaling and/or SIB signaling). In one example resource R is activated or indicated by dynamic signaling, e.g., MAC CE signaling and/or L1 control signaling.

In this disclosure, priority or level of sensing is used to determine or indicate whether a resource can be used by a UE (e.g., the UE 116) without sensing or LBT (e.g., resource that is with high priority), or whether a resource can be used by the UE after sensing or LBT (e.g., a resource that is not with a high priority) for clear channel assessment (CCA). Furthermore, the priority of a resource can indicate a level of sensing or LBT performed, e.g., a resource with lower priority can require more sensing or LBT in terms of longer duration or of a lower energy detection threshold for the resource to be regarded as unavailable.

In this disclosure, a priority or level of sensing of resource can be substituted by a priority or level of sensing of a transmission in the resource or a priority or level of sensing of a user or transmitting device transmitting in the resource. For example, a first level/parameters of sensing or LBT can apply for a first transmission with priority or level of sensing 0 and a second level/parameters of sensing or LBT can apply for a second transmission with priority or level of sensing 1. In one example, priority 0 or level of sensing 0, can indicate that the transmitting device can use the resource without sensing if it has data to transmit.

A resource R can be configured by a network for at least two users, a first user is indicated or activated or configured or has by default a first priority or level of sensing p₀ and a second user is indicated or activated or configured or has by default a second priority or level of sensing p₁. In one example, p₀ and p₁ indicate a higher priority for the first user than the second user. In one example, p₀=0, p₁=1, and then the second priority is higher than the first priority. Similarly, a user can be configured/activated/indicated multiple resources and can also be configured/indicated a priority for each of the multiple resources. In one example, a user can be configured/activated/indicated a first resource R₀ with a first priority p₀ and a second resource R₁ with a second priority p₁. The first and second resources R₀ and R₁ can also be configured/activated/indicated with parameters for sensing/LBT, including no sensing/LBT, or those parameters can be separately configured/activated/indicated for the respective first and second priorities p₀ and p₁ and be dependent on the priority for a resource, instead of the resource itself, and same for resources with same indicated/activated/configured priority.

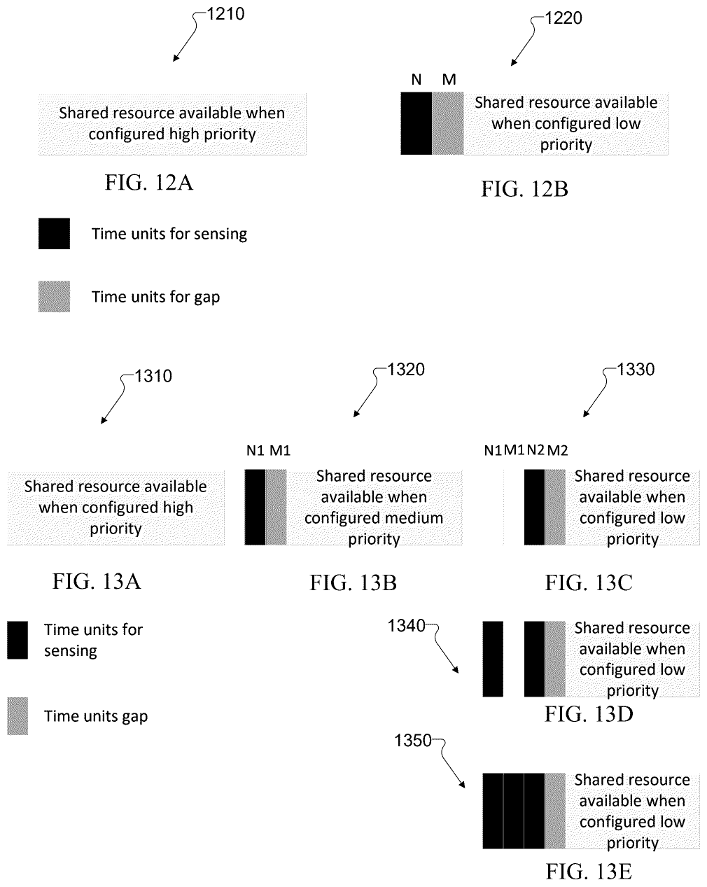

FIGS. 12A and 12B illustrate diagrams of an example resource configurations 1210 and 1220 according to embodiments of the present disclosure. For example, resource configurations 1210 and 1220 can be utilized by any of the UEs 111-116 of FIG. 1 and/or any of the users described herein. This example is for illustration only and other embodiments can be used without departing from the scope of the present disclosure.

In one example, for a resource R, a user is indicated/activated/configured if it is a user with a first priority or level of sensing or with a second priority or level of sensing for resource R. For example, a first user can be indicated/activated/configured a first, higher, priority for resource R, and a second user can be indicated/activated/configured a second, lower, priority for resource R. In one example, the first priority or level of sensing is configured such that the user starts to transmit in the slot if it has data to transmit with no sensing.
If the first user has traffic to transmit in resource R, the first user starts transmitting from the first symbol of the resource as illustrated in FIG. 12. In one example, the gNB can sense or detect the presence or non-presence of a transmission from the first user, e.g., by sensing or detecting if there is signal on the first N time-units of the first user. If the gNB detects the presence of the first user, the gNB receives the first user. In one example, if the gNB doesn't detect the presence of the first user, the gNB receives or detects the presence of the second user.
If the second user has traffic to transmit in the resource R (or if the first user has traffic to transmit in the resource R and the first user is indicated a lower priority for resource R), the second user (or the first user)
   senses (e.g., performs listen-before-talk (LBT)) the resource/channel during the first N time units of the configured resource. In one example, a time unit is a symbol. In one example, N=1. In one example, N is defined in the system specifications. In one example N is configured and/or updated by higher layer signaling (e.g., SIB and/or RRC) and/or MAC CE signaling and/or L1 control signaling.
   If the resource/channel is determined as used (or as unavailable) based on the sensing (or LBT or CCA), transmission in the configured resource/channel is skipped. The LBT parameters can be associated with the resource or with the priority or level of sensing of the resource.
   If the resource/channel is determined as not used (or as available) based on the sensing (or LBT or CCA), transmission in the configured resource can start from time unit N+M of resource R, as illustrated in FIG. 12, where M is the number of time units between the N sensing time units and the time unit configured for transmission as illustrated in FIG. 12. In one example, a time unit is a symbol. In one example, M=0. In one example, M=1. In one example, M is defined in the system specifications. In one example M is configured and/or updated by higher layer signaling (e.g., SIB and/or RRC) and/or MAC CE signaling and/or L1 control signaling. In one example, if the gNB doesn't detect the presence of the first user, the gNB can sense or detect the presence or non-presence of a transmission from the second user, e.g., by sensing or detecting if there is signal on the first N time-units of the second user. If the gNB detects the presence of the second user, the gNB receives the second user.

With reference to FIG. 12, an example is shown of a resource configured or activated or indicated as a high priority resource for a first user and as a low priority resource for a second user. If the first user has data to transmit, the first user starts transmitting from the start of the resource as illustrated in FIG. 12A. If the second user has data to transmit, the second user first performs sensing (or LBT or CCA) on N time units and if the resource is available, the second user starts transmitting after sensing and after a gap M as illustrated in FIG. 12B. In FIG. 12, a time unit can be a symbol. The parameters for the LBT, including absence of LBT, can be configured/indicated per resource, per priority, or be defined in the specification of the system operation when LBT needs to be performed for a resource or for a priority or level of sensing of a resource. The gap M can be based on the user's processing latency capability.

In one example, a resource R is configured for at least three users and, for the resource R, a first user is indicated or activated or configured or has by default a first priority or first level of sensing p₀, a second user is indicated or activated or configured or has a second priority or second level of sensing p₁, and a third user is indicated or activated or configured or has a third priority or third level of sensing p₂. In one example, p₀, p₁ and p₂ indicate a higher priority for the first user than the second user, and a higher priority for the second user than the third user. Similarly, a user can be configured/activated/indicated multiple resources and can also be indicated or activated or configured a priority or a level of sensing for each of the multiple resources. For example, a user can be configured/activated/indicated a first resource R₀ with a first priority p₀, a second resource R₁ with a second priority p₁, and a third resource R₂ with a third priority p₂. The first, second, and third resources R₀, R₁, and R₂ can also be configured/activated/indicated with parameters for sensing/LBT/CCA, including no sensing/LBT/CCA, or those parameters can be separately configured/activated/indicated for the respective first, second, and third priorities p₀, p₁, p₂ and be dependent on the priority or level of sensing for a resource, instead of the resource itself, and same for resources with same indicated/activated/configured priority or level sensing. In one example, the first priority or level of sensing is configured such that the user starts to transmit in the slot if it has data to transmit with no sensing.

FIGS. 13A, 13B, 13C, 13D, and 13E illustrate diagrams of example resource configurations 1310, 1320, 1330, 1340, and 1350, respectively, according to embodiments of the present disclosure. For example, resource configurations 1310, 1320, 1330, 1340, and 1350, respectively, can be utilized by the UE 116 of FIG. 3 and/or any of the users described herein. This example is for illustration only and other embodiments can be used without departing from the scope of the present disclosure.

In one example, for a resource R, a user is indicated/activated/configured a higher priority (e.g., no or less sensing) or a medium priority (e.g., medium sensing) or a lower priority (e.g., high sensing) for resource R. For example, the first user can be indicated/activated/configured a higher priority for resource R, the second user can be indicated/activated/configured a medium priority for resource R, and the third user can be indicated/activated/configured a lower priority for resource R.
If the first user has traffic to transmit in resource R, it starts transmitting from the first symbol of the resource as illustrated in FIG. 13A. In one example, the gNB can sense or detect the presence or non-presence of a transmission from the first user, e.g., by sensing or detecting if there is signal on the first N1 time-units of the first user. If the gNB detects the presence of the first user, the gNB receives the first user. In one example, if the gNB doesn't detect the presence of the first user, the gNB receives or detects the presence the second user
If the second user has traffic to transmit in the resource R (or if the first user has traffic to transmit in the resource R and the first user is indicated a medium priority for resource R), the second user (or the first user with medium priority)
   senses (e.g., performs listen-before-talk (LBT) or CCA) the resource/channel during the first N1 time units of the configured resource. In one example, a time unit is a symbol. In one example, N1=1. In one example, N1 is defined in the system specifications. In one example N1 is configured and/or updated by higher layer signaling (e.g., SIB and/or RRC) and/or MAC CE signaling and/or L1 control signaling.
   if the resource/channel is determined as used (or as unavailable) based on the sensing (or LBT or CCA), the second user doesn't transmit in the configured resource.
   if the resource/channel is determined as not used (or as available) based on the sensing (or LBT or CCA), the second user transmits in the configured resource starting from time unit N1+M1 of resource R, as illustrated in FIG. 13B, where M1 is the number of time units between the N1 sensing time units and the time unit configured for transmission as illustrated in FIG. 13B. In one example, a time unit is a symbol. In one example, M1=0. In one example, M1=1. In one example, M1 is defined in the system specifications. In one example M1 is configured and/or updated by higher layer signaling (e.g., SIB and/or RRC) and/or MAC CE signaling and/or L1 control signaling. In one example, if the gNB doesn't detect the presence of the first user, the gNB can sense or detect the presence or non-presence of a transmission from the second user, e.g., by sensing or detecting if there is signal on the first N2 time-units of the second user. If the gNB detects the presence of the second user, the gNB receives the second user. In one example, if the gNB doesn't detect the presence of the second user, the gNB receives or detects the presence of the third user.
If the third user has traffic to transmit in the resource R (or if the first user or second user has traffic to transmit in the resource R and the first user or second user is indicated a low priority for resource R), the third user (or the first user or the second user with low priority)
   senses (e.g., performs listen-before-talk (LBT) or CCA) the resource/channel
      In one example, sensing is in N2 time units after the first N1+M1 time units of resource R as illustrated in FIG. 13C. In one example, a time unit is a symbol. In one example, N2=1. In one example, N2 is defined in the system specifications. In one example N2 is configured and/or updated by higher layer signaling (e.g., SIB and/or RRC) and/or MAC CE signaling and/or L1 control signaling.
      In one example, sensing is in the first N1 time units of resource R and in N2 time units after the first N1+M1 time units as illustrated in FIG. 13D. In one example, a time unit is a symbol.
      In one example, sensing is in the first N1+M1+N2 time units of resource R as illustrated in FIG. 13E. In one example, a time unit is a symbol.
   If the resource/channel is determined as used (or as unavailable) based on the sensing (or LBT), a transmission in the configured resource is skipped.
   If the resource/channel is determined as not used (or as available) based on the sensing (or LBT), it transmits in the configured resource starting from time unit N1+M1+N2+M2 of resource R, as illustrated in FIG. 13C/D/E, where M2 is the number of time units between the N2 sensing time units and the time unit configured for transmission as illustrated in FIG. 13C/D/E. In one example, a time unit is a symbol. In one example, M2=0. In one example, M2=1. In one example, M2 is defined in the system specifications. In one example M2 is configured and/or updated by higher layer signaling (e.g., SIB and/or RRC) and/or MAC CE signaling and/or L1 control signaling. In one example, if the gNB doesn't detect the presence of the first and second users, the gNB can sense or detect the presence or non-presence of a transmission from the third user, e.g., by sensing or detecting if there is signal on the first N3 time-units of the third user. If the gNB detects the presence of the third user, the gNB receives the third user.

With reference to FIG. 13, an example is shown of a resource configured or activated or indicated as a high priority resource (e.g., no or less sensing) for a first user, as a medium priority resource (e.g., medium sensing) for a second user, and as a low priority (e.g., high sensing) resource for a third user. If the first user has data to transmit, the first user starts transmitting from the start of the resource as illustrated in FIG. 13A. If the second user has data to transmit, the second user first performs sensing (or LBT) on N1 time units and if the resource is available, the second user starts transmitting after sensing and after a gap M1 as illustrated in FIG. 13B. The gap M1 can be based on the user's processing latency capability. If the third user has data to transmit, the third user first performs sensing (or LBT) on (1) N2 time units or (2) N1 and N2 time units or (3) N1+M1+N2 time units and if the resource is available, the third user starts transmitting after sensing and after a gap M2 as illustrated in FIG. 13C or FIG. 13D or FIG. 13E. In FIG. 13, a time unit can be a symbol. The gap M2 can be based on the user's processing latency capability.

In the examples mentioned herein, sensing (or LBT or CCA) can be measuring one of:
The reference signal received power (RSRP) e.g., over N time units (e.g., symbols), and across the resource blocks (RBs) of a resource. The reference signal can be a CSI-RS, a DM-RS, a SRS, and so on. In one example, N=1.
The reference signal received quality (RSRQ) e.g., over N time units (e.g., symbols), and across the RBs of a resource. The reference signal can be a CSI-RS, a DM-RS, a SRS, and so on. In one example, N=1.
The received signal strength indicator (RSSI) e.g., over N time units (e.g., symbols), and across the RBs of a resource. The RSSI can be the received power over N time units (e.g., symbols), and across the RBs of a resource.
The signal to noise ratio (SINR) e.g., over N time units (e.g., symbols), and across the RBs of a resource. In one example, N=1.

In one example, the time units over which sensing (e.g., LBT or CCA) is performed are used for DMRS or other reference signal (e.g., CSI-RS or SRS) for users transmitting in those resources/tine-units in resource R.

In the examples mentioned herein, a user determines if a resource is used by comparing the measurement (e.g., RSRP or SINR or RSSI) over the sensed time units against a threshold. If the measurement is larger than (or larger than or equal to) a threshold, the resource is used or occupied, otherwise the resource is available. Wherein the threshold can be configured and/or updated by higher layer signaling (e.g., SIB and/or RRC) and/or MAC CE signaling and/or L1 control signaling. In one example, the threshold depends on a priority or level of sensing of a corresponding transmission from the user performing the sensing (or LBT or CCA). In one example, the threshold depends on a priority of a transmission occupying the shared resource. In one example, the level of sensing is determined by the number of time-units (e.g., N1, N2, N1++M1+N2) to sense and/or a threshold to compare the sensing metric to determine if the resource is used or not.

In one example, a user transmits a reference signal (e.g., DMRS or SRS or CSI-RS) in a time unit (e.g., symbol) sensed by another user. In one example, the sequence of the reference signal can determine the priority of the user transmitting in the shared resource.

In the example, of FIG. 13, if a user performing sensing or LBT or CCA, determines that a resource is occupied or not available based on sensing in sensing occasion corresponding to N1 time units, the resource is occupied by a high priority transmission. Otherwise, if a user performing sensing or LBT or CCA, determines a shared resource is occupied or not available based on sensing in sensing occasion corresponding to N2, but not N1, the resource is occupied by a medium priority transmission.

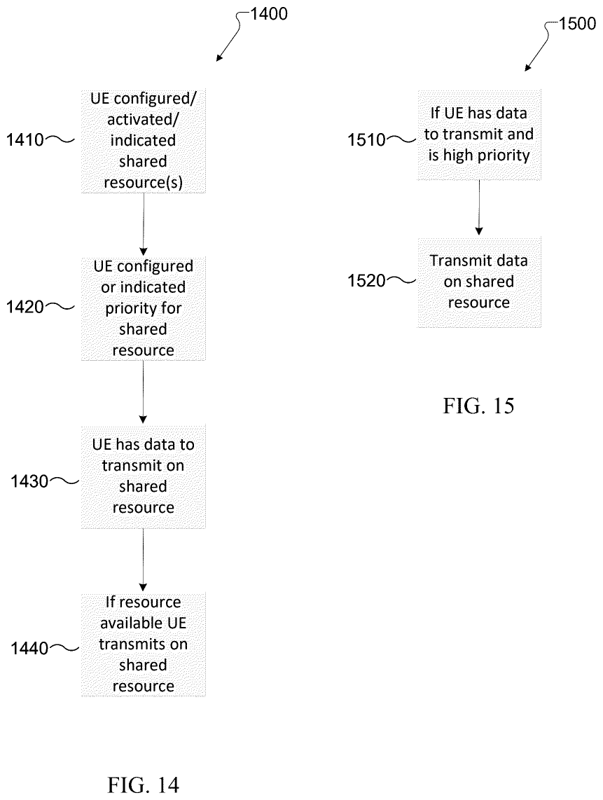

FIG. 14 illustrates a flowchart of an example UE procedure 1400 for transmitting on a shared resource according to embodiments of the present disclosure. For example, procedure 1400 can be performed by any of the UEs 111-116 of FIG. 1, such as the UE 116, and/or any of the users described herein. This example is for illustration only and other embodiments can be used without departing from the scope of the present disclosure.

The procedure begins in 1410, a UE is configured/activated/indicated a shared resource(s). In 1420, the UE is configured or activated or indicated priority or level of sensing for shared resource. In 1430, the UE has data to transmit on shared resource. In 1440, if the resource is available, the UE transmits on the shared resource.

With reference to FIG. 14, an example of the procedure mentioned herein:
In a first step, the user is configured or activated or indicated resource(s). These resources can be shared with other users. For example, these resources can be configured grant resources (e.g., CG PUSCH). In another example, these resources can be dynamically configured resources, e.g., using a DCI format for uplink grant. The configuration or activation or indication of the resource(s) can be by higher layer signaling (e.g., SIB and/or RRC) and/or MAC CE signaling and/or L1 control signaling.
In a second step, the user is configured or activated or indicated a priority or level of sensing of the resource(s). The configuration or activation or indication of the priority can be by higher layer signaling (e.g., SIB and/or RRC) and/or MAC CE signaling and/or L1 control signaling. In one example, for CG-resource (e.g., CG-PUSCH), the priority or level of sensing is configured with the resource configuration. In one example, for CG-resource (e.g., Type-2 CG-PUSCH), the priority or level of sensing is indicated in the channel (e.g., MAC-CE or DCI Format) activate Type-2 CG-PUSCH). In one example, for dynamically configured resources, the priority or level of sensing is included in the DCI format of the uplink grant. In a variant example, the priority can be replaced by an indication of how to use the resource, e.g., to transmit from the start of resource, or to perform sensing (or LBT or CCA) first before transmitting, and for how long to perform sensing. In one example, a signal can be transmitted by the network and received by the UE to indicate a priority or level of sensing of a resource(s), the UE applies the priority of the resource after a processing delay from the signal or from the acknowledgment (e.g., positive ACK) to the signal for all transmissions until a new signal is received that indicates a new priority and the processing delay corresponding to that signal or the acknowledgement (e.g., positive ACK) to the signal.
In a third step, a user has data to transmitted on the resource.
In a fourth step, a user determines if the resource is available for transmission based on the priority or indication (e.g., level of sensing indication) provided in step 2.

FIG. 15 illustrates a flowchart of an example UE procedure 1500 for transmitting data on a shared resource according to embodiments of the present disclosure. For example, procedure 1500 can be performed by the UE 116 of FIG. 3 and/or any of the users described herein. This example is for illustration only and other embodiments can be used without departing from the scope of the present disclosure.

The procedure begins in 1510, a UE determines if the UE (itself) has data to transmit and is high priority (e.g., with level of sensing indicating no sensing). In 1520, if the UE determines that the UE (itself) has data to transmit and is high priority, the data is transmitted on a shared resource.

With reference to FIG. 15, an example is shown of the procedure mentioned herein for a user with a high priority resource (e.g., no or less sensing), or a user that is indicated to transmit in a resource without sensing or LBT or CCA. If a user has data to transmit and the resource is a higher priority resource, or if a user has data to transmit and the user is indicated to transmit in resource without sensing or LBT or CCA, the user transmits the data on the resource.

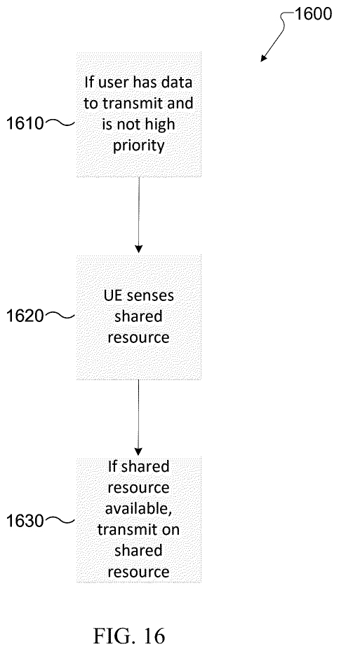

FIG. 16 illustrates a flowchart of an example UE procedure 1600 for transmitting on a shared resource according to embodiments of the present disclosure. For example, procedure 1600 can be performed by any of the UEs 111-116 of FIG. 1, such as the UE 115, and/or any of the users described herein. This example is for illustration only and other embodiments can be used without departing from the scope of the present disclosure.

The procedure begins in 1610, a UE/user determines if the UE/user (itself) has data to transmit and is not high priority. In 1620, if the UE/user determines that the UE/user (itself) has data to transmit and is not high priority, the UE/user senses a shared resource. In 1630, if the shared resource is available, the UE/user transmits on the shared resource.

FIG. 16 illustrates an example of the procedure mentioned herein for a user with a resource that is not a high priority resource (e.g., determined based on a level of sensing), or a user that is indicated to transmit in a resource after sensing or LBT or CCA, and is indicated information on the sensing duration and a threshold to compare the sensing metric to as described herein. If a user has data to transmit and the resource is not a high priority resource, or if a user has data to transmit and the user is indicated to transmit after sensing or LBT or CCA:
The user first performs sensing or LBT or CCA on the resource using a sensing time as indicated. The sensing metric obtained during sensing, as described herein, is a compared to a threshold to determine if the resource is available or not available. In one example, if the sensing metric is higher than (or higher than or equal to) a threshold the resource is not available, otherwise the resources is available. In another example, if the sensing metric is lower than (or lower than or equal to) a threshold the resource is not available, otherwise the resources is available.
If the resource is available, the user transmits on the resource; otherwise, when the resource is not available, there is no transmission from the user on the resource.

In one example a user is configured activated or indicated a resource R. A user is configured or activated or indicated a priority. Alternatively, a user is configured or activated or indicated an indicator that determines whether the UE performs sensing/LBT/CCA or not before transmitting in the resource and the level of sensing/LBT/CCA (e.g., sensing duration and/or threshold for detecting the resource as available or unavailable). The user has data to transmit in the resource R.
If the user has a high priority (e.g., no or less sensing) or if the user is indicated to transmit in resource R without sensing, the user proceeds with transmission of data in resource R.
Else, the user performs sensing/LBT/CCA based on the configured or indicated sensing level.
   If resource is available based on sensing/LBT/CCA, user transmits in resource as described in this disclosure based on the priority level or the indicator (e.g., indicator of the level of sensing).
   Else (resource is not available), the resource is skipped.

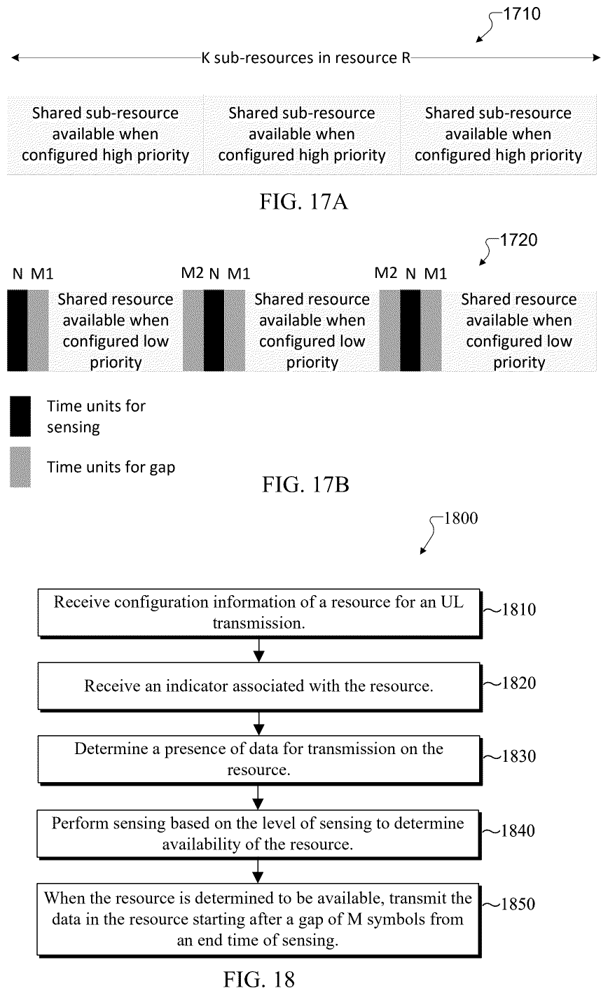

A resource R is configured for at least two users, a first user has a first priority or first sensing level p₀ and a second user has a second priority or second sensing level p₁. In one example, p₀ and p₁ indicate a higher priority for the first user than the second user. In one example, p₀=1 and p₀=0. Furthermore, the first user has a shorter transmission time interval than the second user. For example, the resource R can be first divided into K sub-resources for the first user as illustrated in FIG. 17A. The first user can transmit on one or more of the K sub-resources. In one example, a user is indicated/activated/configured the priority or level of sensing for the resource R, from a number of priorities or levels of sensing for the resource R, and the user can determine whether the user has a higher priority or a lower priority for resource R and/or the sub-resources of resource R. For example, the first user can be indicated/activated/configured a higher priority for resource R and its sub-resources, and the second user can be indicated/activated/configured a lower priority for resource R.
If the first user has a transmission in a sub-resource of resource R, the first user starts transmitting from the first symbol of the sub-resource as illustrated in FIG. 17A.
If the second user has a transmission in the resource R, the second user
   senses (e.g., performs listen-before-talk (LBT) or CCA) the resource/channel during the first N time units of the configured resource. In one example, a time unit is a symbol. In one example, N=1. In one example, N is defined in the system specifications. In one example N is configured and/or updated by higher layer signaling (e.g., SIB and/or RRC) and/or MAC CE signaling and/or L1 control signaling.
   if the resource/channel is determined to be used based on the sensing (or LBT or CCA), the second user doesn't transmit in the configured resource.
   if the resource/channel is determined to not be used based on the sensing (or LBT), the second user transmits in the configured resource starting from time unit N+M1 of resource R, as illustrated in FIG. 17B, where M1 is a number of time units between the N sensing time units and the time unit configured for transmission as illustrated in FIG. 17B. In one example, a time unit is a symbol. In one example, M1=0. In one example, M1=1. In one example, M1 is defined in the system specifications. In one example M1 is configured and/or updated by higher layer signaling (e.g., SIB and/or RRC) and/or MAC CE signaling and/or L1 control signaling. The gap M1 can be based on the user's processing latency capability.
   continues transmission (if the second user is transmitting) until M2 time units before the next sensing occasion. There is a gap of M2 time units before each sensing occasion as illustrated in FIG. 17B. In one example, a time unit is a symbol. In one example, M2=0. In one example, M2=1. In one example, M2 is defined in the system specifications. In one example M2 is configured and/or updated by higher layer signaling (e.g., SIB and/or RRC) and/or MAC CE signaling and/or L1 control signaling. The second user performs sensing (e.g., performs listen-before-talk (LBT) or CCA) in N time units of the next sensing occasion (e.g., at start of next sub-resource). If the second user determines that the channel is used based on the sensing (or LBT or CCA), it stops transmission. If the second user determines that the channel is not used based on the sensing (or LBT or CCA), it continues transmission in the configured resource starting from M1 time units after the sensing occasions. The gap M1 can be based on the user's processing latency capability.
   The procedure mentioned herein for the second user continues for the next sensing occasions (e.g., at start of next sub-resource) until the end of the resource R.
   In one example, if the second user doesn't transmit as a result of sensing (or LBT or CCA) in one of the sensing occasions and determination that the corresponding sub-resource is occupied (e.g., not available), the second user doesn't transmit in any of the remaining sub-resources of resource R. In one example, the second user doesn't perform sensing or LBT or CCA in any of the remaining sensing occasions of resource R.
   In one example, if the second user doesn't transmit as a result of sensing (or LBT or CCA) in one of the sensing occasions and determination that the corresponding sub-resource is occupied (e.g., not available), the second user can transmit in a future sub-resource of resource R if the second user determines that the future sub-resource of resource R is not occupied (e.g., is available).

FIGS. 17A and 17B illustrate diagrams of example resource configurations 1710 and 1720 according to embodiments of the present disclosure. For example, configurations 1710 and 1720 can be utilized by the UE 116 of FIG. 3 and/or any of the users described herein. This example is for illustration only and other embodiments can be used without departing from the scope of the present disclosure.

With reference to FIG. 17A, an example is shown of a resource configured as a high priority resource (e.g., with no or less sensing) for a first user and as a low priority resource (e.g., with more sensing) for a second user. Furthermore, for the first user the resource R is divided into K sub-resources. The first user can transmit in any, some or each of the K sub-resources. If the first user has a transmission, the first user starts transmitting from the start of a sub-resource as illustrate in FIG. 17A. If the second user has a transmission, the second user first performs sensing (or LBT) on N time units and, if the resource is available, the second user starts transmitting after sensing and after a gap M1 as illustrated in FIG. 17B. The second user performs additional sensing at the start of each sub-resource. If the second user determines that the resource is occupied, the second user stops transmission. In one example, when a sub-resource is occupied the second user stops transmission for the remainder of the resource. In another example, the second user can transmit in sub-resources that are not occupied. In FIG. 17B, a time unit can be a symbol. The gap M1 or M2 can be based on the user's processing latency capability.

In one example a user is configured or activated or indicated a resource R. The resource R is divided into sub-resources R1, R2, . . . . A user is configured or activated or indicated a priority or level of sensing. Alternatively, a user is configured or activated or indicated an indicator that determines whether the UE (e.g., the UE 116) performs sensing/LBT/CCA or not before transmitting in the resource, and the level of sensing/LBT/CCA (e.g., sensing duration and/or threshold for detecting the resource as available or unavailable). The user has data to transmit in the resource R or sub-resource of resource R.
If the user has a high priority or if the user is indicated to transmit in resource R without sensing, the user proceeds with transmission of data in resource R or in a sub-resource of resource R.
Else, the user performs sensing/LBT/CCA based on the configured or activated or indicated sensing level.
   If resource is available based on sensing/LBT/CCA, user transmits in resource as described in this disclosure based on the priority level or the indicator (e.g., sensing level indicator). The user performs additional sensing/LBT/CCA for each sub-resource, if a sub-resource is available based on sensing/LBT/CCA, user continues its transmission, else (sub-resource is not available), user aborts transmission in the resource.
   Else (resource is not available), the resource is skipped.
   In one example, if the gNB is receiving a lower priority user in the resource, at the start of a sub-resource, the gNB can sense or detect the presence or non-presence of a transmission from the higher priority user in the sub-resource, e.g., by sensing or detecting if there is signal on the first N time-units of sub-resource from the higher priority user. If the transmission from the higher priority user is present or detected, the gNB stops receiving the lower priority user in the resource, and the gNB receives the higher priority user in the sub-resource. If the transmission from the higher priority user is not present or not detected, the gNB continues receiving the lower priority user.

In one example, a user is configured or activated or indicated a resource R. The resource R is divided into sub-resources R1, R2, . . . . A user is configured or activated or indicated a priority or level of sensing. Alternatively, a user is configured or activated or indicated an indicator that determines whether the UE performs sensing/LBT/CCA or not before transmitting in the resource, and the level of sensing/LBT/CCA (e.g., sensing duration and/or threshold for detecting the resource as available or unavailable). The user has data to transmit in the resource R or sub-resource of resource R.
If the user has a high priority or if the user is indicated to transmit in resource R without sensing, the user proceeds with transmission of data in resource R or in a sub-resource of resource R.
Else, the user performs sensing/LBT/CCA based on the configured or activated or indicated sensing level for each sub-resource of the resource.
   If sub-resource is available based on sensing/LBT/CCA, user transmits in sub-resource as described in this disclosure based on the priority level or the indicator (e.g., sensing level indicator).
   Else (sub-resource is not available), the sub-resource is skipped.
   In one example, if the gNB is receiving a lower priority user in the resource, at the start of a sub-resource, the gNB can sense or detect the presence or non-presence of a transmission from the higher priority user in the sub-resource, e.g., by sensing or detecting if there is signal on the first N time-units of sub-resource from the higher priority user. If the transmission from the higher priority user is present or detected, the gNB skips receiving the lower priority user in the sub-resource, and the gNB receives the higher priority user in the sub-resource. If the transmission from the higher priority user is not present or not detected, the gNB continues receiving the lower priority user.

In one example of this disclosure, a user performs senses/LBT/CCA on part of a time unit (e.g., symbol) to be able to start transmission at the start of the next time unit (e.g., symbol).

In one example, an uplink resource, R, is shared among multiple UEs that are configured with different priorities for the resource, or with different indications for how to use the resource R. The users performing sensing and transmission are user equipments (UEs).

In one example, a downlink resource, R, is shared between multiple gNBs or multiple operators configured with different priorities for the resource, or with different indications for how to use the resource. The users performing sensing and transmission are gNBs (or TRPs or open radio access network (O-RAN) remote units (O-RUs)). In one example, the gNBs (e.g., the BS 102 and the BS 103) belong to the same operator. In one example, the gNBs belong to different operators. In one example a first gNB is a terrestrial gNB and a second gNB is a non-terrestrial gNB such as a satellite.

In one example, a uplink resource, R, is shared between multiple gNBs or multiple operators configured with different priorities for the resource, or with different indications for how to use the resource. The scheduler (of gNB or operator) indicates to the scheduled/configured UE the priority or level of sensing based on the priority or level of sensing of the gNB or operator. The users performing sensing and transmission are UEs scheduled by different gNBs or operators. In one example, the gNBs (e.g., the BS 102 and the BS 103) belong to the same operator. In one example, the gNBs belong to different operators. In one example a first gNB is a terrestrial gNB and a second gNB is a non-terrestrial gNB such as a satellite.

In one example, a user or a transmitting device is configured with a list of priority levels or a list of sensing levels. In one example, a priority level or a sensing level includes a number of time-units (e.g., symbols) to sense (including possibly no time-units for sensing). In one example, the user determines a sensing metric based on sensing. In one example, a priority level or a sensing level includes a threshold to compare the sensing metric with, and based on the comparison a UE determines the availability of the resource for transmission.

In one example, a priority level or sensing level (level of sensing) from the list of priority levels or the list of sensing levels is indicated to the user or transmitting device in a message scheduling or activating or configuration the resources for transmission. In one example, a priority level or sensing level (level of sensing), e.g., sensing duration and threshold are indicated to the user or transmitting device in a message scheduling or activating or configuration the resources for transmission. In one example, the priority level or the level of sensing is indicated to the user or transmitting device in a DCI Format scheduling the resources (e.g., DCI Format 0_0 or DCI Format 0_1 or DCI Format 0_2 in NR). In one example, the UL resources are configured as Type-2 CG-PUSCH, a message (e.g., MAC CE or DCI Format) activates the Type-2 CG-PUSCH, the priority level or the level of sensing is indicated to the user or transmitting device in the message activating Type-2 CG-PUSCH. In one example, the UL resources are configured as Type-1 or Type-2 CG-PUSCH, the priority level or the level of sensing is indicated to the user or transmitting device in the message configuring Type-1 or Type-2 CG-PUSCH.

In one example, a priority level or sensing level (level of sensing) from the list of priority levels or the list of sensing levels is indicated to the user or transmitting device in a message. In one example, a priority level or sensing level (level of sensing), e.g., sensing duration and threshold are indicated to the user or transmitting device in a message. In one example, the message can SIB or RRC or MAC CE or L1 control (e.g., DCI Format). In one example, the user or transmitting device applies the priority level or level of sensing after a time T from (a start or end of) a channel or signal carrying the message. In one example, the user or transmitting device applies the priority level or level of sensing in a first slot (or sub-frame or frame) that starts at least a time T from (a start or end of) a channel or signal carrying the message. In one example, the user or transmitting device applies the priority level or level of sensing after a time T from (a start or end of) a channel or signal carrying an acknowledgment (e.g., positive HARQ) to the message. In one example, the user or transmitting device applies the priority level or level of sensing in a first slot (or sub-frame or frame) that starts at least a time T from (a start or end of) a channel or signal carrying an acknowledgment (e.g., positive HARQ) to the message. In one example, time T can be units of symbols or slots or sub-frames or frames. In one example, T is defined in the system specifications and/or configured or updated by SIB or RRC or MAC CE or L1 control (e.g., DCI Format). In the aforementioned examples, slot can be based on the sub-carrier spacing of the channel or signaling carrying the message and/or the acknowledgment to the message and/or UL BWP and/or DL BWP.

In one example, a sidelink resource is shared between multiple UEs configured with different priorities, or with different indications on how to use the resource. The users performing sensing and transmission are user equipments (UEs).

FIG. 18 illustrates an example method 1800 performed by a UE in a wireless communication system according to embodiments of the present disclosure. The method 1800 of FIG. 18 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1800 is for illustration only and other embodiments can be used without departing from the scope of the present disclosure.

The method 1800 begins with the UE receiving configuration information of a resource for an UL transmission (1810). The UE then receives an indicator associated with the resource (1820). For example, in 1820, the indicator indicates a level of sensing for the resource. In various embodiments, the UE receives a DCI format. The DCI format schedules the resource, and the DCI format includes the indicator associated with the resource. In various embodiments, the configuration information is provided in a message configuring a configured grant PUSCH and the message includes the indicator associated with the resource. In various embodiments, the UE receives a message with the indicator and the indicator is associated with the resource starting after a time T from an acknowledgment of the message.

The UE then determines a presence of data for transmission on the resource (1830). The UE then performs sensing based on the level of sensing to determine availability of the resource (1840). In various embodiments, the level of sensing includes a number of symbols over which to measure a metric and a threshold. The resource is available when the metric is less than the threshold. In various embodiments, the level of sensing is configured to indicate that the resource is available for transmission with no sensing.

The UE then, when the resource is determined to be available, transmit the data in the resource starting after a gap of M symbols from an end time of sensing (1850). For example, in 1850, M is a non-negative integer. In various embodiments, the resource is partitioned into a plurality of sub-resources and the UE, when the transmission of the data in the resource starts, performs sensing based on the level of sensing at a start time of a sub-resource, from the plurality of sub-resources, and when sensing indicates that the sub-resource is not available, stops transmission in the resource.

Any of the above variation embodiments can be utilized independently or in combination with at least one other variation embodiment.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive configuration information of a resource for an uplink (UL) transmission, and
receive an indicator associated with the resource, wherein the indicator indicates a level of sensing for the resource; and
a processor operably coupled to the transceiver, the processor configured to determine a presence of data for transmission on the resource,
wherein the transceiver is further configured to:
perform sensing based on the level of sensing to determine availability of the resource, and
when the resource is determined to be available, transmit the data in the resource starting after a gap of M symbols from an end time of sensing, where M is a non-negative integer.

2. The UE of claim 1, wherein:
the transceiver is further configured to receive a downlink control information (DCI) format,
the DCI format schedules the resource, and
the DCI format includes the indicator associated with the resource.

3. The UE of claim 1, wherein:
the configuration information is provided in a message configuring a configured grant physical uplink shared channel (PUSCH), and
the message includes the indicator associated with the resource.

4. The UE of claim 1, wherein:
the transceiver is further configured to receive a message with the indicator, and
the indicator is associated with the resource starting after a time T from an acknowledgment of the message.

5. The UE of claim 1, wherein:
the level of sensing includes:
a number of symbols over which to measure a metric, and
a threshold; and
the resource is available when the metric is less than the threshold.

6. The UE of claim 1, wherein the level of sensing is configured to indicate that the resource is available for transmission with no sensing.

7. The UE of claim 1, wherein:
the resource is partitioned into a plurality of sub-resources,
the transceiver is further configured to:
when the transmission of the data in the resource starts, perform sensing based on the level of sensing at a start time of a sub-resource, from the plurality of sub-resources, and
when sensing indicates that the sub-resource is not available, stop transmission in the resource.

8. A base station (BS), comprising:
a transceiver configured to:
transmit configuration information of a resource for an uplink (UL) transmission, and
transmit an indicator associated with the resource, wherein the indicator indicates a level of sensing for the resource; and
a processor operably coupled to the transceiver, the processor configured to determine whether a first transmission is present in the resource associated with a first level of sensing,
wherein the transceiver is further configured to, when the first transmission is present, receive the first transmission,
wherein the processor is further configured to, when the first transmission is not present, determine whether a second transmission is present in the resource associated with a second level of sensing, and
wherein the transceiver is further configured to, when the second transmission is present, receive the second transmission.

9. The BS of claim 8, wherein:
the transceiver is further configured to transmit a downlink control information (DCI) format,
the DCI format schedules the resource, and
the DCI format includes the indicator associated with the resource.

10. The BS of claim 8, wherein:
the configuration information is provided in a message configuring a configured grant physical uplink shared channel (PUSCH), and
the message includes the indicator associated with the resource.

11. The BS of claim 8, wherein:
the transceiver is further configured to transmit a message with the indicator, and
the indicator is associated with the resource starting after a time T from an acknowledgment of the message.

12. The BS of claim 8, wherein:
the level of sensing includes:
a number of symbols over which to measure a metric, and
a threshold; and
the resource is available when the metric is less than the threshold.

13. The BS of claim 8, wherein the level of sensing is configured to indicate that the resource is available for transmission with no sensing.

14. The BS of claim 8, wherein:
the resource is partitioned into a plurality of sub-resources,
the processor is further configured to, when the reception in the resource starts for the second transmission, determine whether a third transmission associated with a first level of sensing at a start time of a sub-resource, from the sub-resources, is present, and
the transceiver is further configured to:
when the third transmission is present, stop reception of the second transmission and receive the third transmission,
when third transmission is not present, continue reception of second transmission.

15. A method of operating a user equipment (UE), the method comprising:
receiving configuration information of a resource for an uplink (UL) transmission;
receiving an indicator associated with the resource, wherein the indicator indicates a level of sensing for the resource;
determining a presence of data for transmission on the resource;
performing sensing based on the level of sensing to determine availability of the resource; and
when the resource is determined to be available, transmitting the data in the resource starting after a gap of M symbols from an end time of sensing, where M is a non-negative integer.

16. The method of claim 15, wherein:
receiving the indicator associated with the resource comprises receiving a downlink control information (DCI) format that includes the indicator associated with the resource, and
the DCI format schedules the resource.

17. The method of claim 15, wherein:
the configuration information is provided in a message configuring a configured grant physical uplink shared channel (PUSCH), and
the message includes the indicator associated with the resource.

18. The method of claim 15, wherein:
the level of sensing includes:
a number of symbols over which to measure a metric, and
a threshold; and
the resource is available when the metric is less than the threshold.

19. The method of claim 15, wherein the level of sensing is configured to indicate that the resource is available for transmission with no sensing.

20. The method of claim 15, wherein:
the resource is partitioned into a plurality of sub-resources, and
the method further comprises:
when the transmission of the data in the resource starts, performing sensing based on the level of sensing at a start time of a sub-resource, from the plurality of sub-resources and
when sensing indicates that the sub-resource is not available, stopping transmission in the resource.
